(19) United States
(12) Patent Application Publication
(10) Pub. No.: US 2020/0112582 A1
(43) Pub. Date: Apr. 9, 2020

(54) NOTIFICATION OF A VULNERABILITY RISK LEVEL WHEN JOINING A SOCIAL GROUP

(71) Applicant: International Business Machines Corporation, Armonk, NY (US)

(72) Inventors: Al Chakra, Apex, NC (US); Kevin Carr, Raleigh, NC (US); Faisal Ghaffar, Dunboyne (IE); Ahmad Abdul Wakeel, Dublin (IE)

(21) Appl. No.: 16/150,341

(22) Filed: Oct. 3, 2018

(51) Int. Cl. H04L 29/06; H04L 29/08; G06F 21/46; G06F 9/54; G06Q 50/00

(52) U.S. Cl. CPC H04L 63/1433; H04L 67/306; G06Q 50/01; G06F 9/542; G06F 21/46

(57) ABSTRACT

Provided are techniques for generating notifications of a vulnerability risk level when joining a social media group analyzing user and configuration data for one or more group members of a group, calculating a vulnerability score for the one or more group members based on the analysis, and calculating an aggregated group score based on the vulnerability score for the one or more group members. The techniques also includes calculating a group threshold for the group based on a risk event, comparing the group threshold and the aggregated group score, and notifying a user of a vulnerability risk level of the group based on the comparison.

### BACKGROUND

The present invention generally relates to social networking systems, and more specifically to notification of vulnerability risk level when joining a social group of a social network.

Social networking systems allow users to interact with other members that have like interests or associations. Social networking systems also provide users with the ability to form groups and subgroups with other users having similar interests and associations. The groups can be based on interests such as sports, schools, music, or other types of groups. Users are able to share media, files, and other content over the social media network. In addition, users are able to publish posts with varying levels of privacy. For example, posts can be limited to only the group members, or in another example, the posts can be limited to friends of the user publishing the post. The users can include individual users or businesses where respective profiles are maintained. There may be a need to manage the posts that are published by the user or related to the user.

### SUMMARY

Embodiments of the present invention are directed to a computer-implemented method for notification of a vulnerability risk level when joining a social group. A non-limiting example of the computer-implemented method includes analyzing user and configuration data for one or more group members of a group, calculating a vulnerability score for the one or more group members based on the analysis, and calculating an aggregated group score based on the vulnerability score for the one or more group members. The computer-implemented method also includes calculating a group threshold for the group based on a risk event, comparing the group threshold and the aggregated group score, and notifying a user of a risk level of the group based on the comparison.

Embodiments of the present invention are directed to a system for notification of a vulnerability risk level when joining a social group. A non-limiting example of the system includes a storage medium, the storage medium being coupled to a processor. The processor is configured to analyze user data and configuration data for one or more group members of a group, calculate a vulnerability score for the one or more group members based on the analysis, and calculate an aggregated group score based on the vulnerability score for the one or more group members. The processor is also configured to calculate a group threshold for the group based on a risk event, compare the group threshold and the aggregated group score, and notify a user of a risk level of the group based on the comparison.

Embodiments of the invention are directed to a computer program product for notification of a vulnerability risk level when joining a social group, the computer program product comprising a computer readable storage medium having program instructions embodied therewith. The program instructions are executable by a processor to cause the processor to perform a method. A non-limiting example of the method includes analyzing user and configuration data for one or more group members of a group, calculating a vulnerability score for the one or more group members based on the analysis, and calculating an aggregated group score based on the vulnerability score for the one or more group members. The method also includes calculating a group threshold for the group based on a risk event, comparing the group threshold and the aggregated group score, and notifying a user of a risk level of the group based on the comparison.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating one example of a processing system for practice of the teachings herein;

FIG. 2 depicts a system for generating notifications of a vulnerability risk level when joining a social media group in accordance with one or more embodiments;

FIG. 3 depicts a flowchart of a method for generating notifications of a vulnerability risk level when joining a social media group in accordance with one or more embodiments of the invention; and

FIG. 4 depicts a computer program product for generating notifications of a vulnerability risk level when joining a social media group in accordance with one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, social media platforms allow users to interact with other users over the social media network from the convenience of their mobile devices, laptops, computers, etc. Users can use social media to share content and interests, make purchases, manage their profiles and much more. Users can also manage privacy levels for the content that is shared or posted. For example, the users can set their setting to public or private to limit the access/exposure of their information.

Because the information can be made public which encourages like-minded users to join their groups, hackers can also gain insight into the interests of a user and leverage the information to attract a user to join a particular social media group to perform some type of cybercrime.

In today's environment, the formation of fraud-dedicated social media groups is on the rise. The intent is to obtain private information such as confidential information, financial information, etc. For example, hackers can lure other users into providing their personal information by generating encouraging them to click on malicious links, opening emails, or joining a group on a social media network. A user's interaction with malicious content can lead to data loss, exposure of confidential and personal information, impact to customer confidence, damage to the reputation the group and/or social media platform and more. Because much of the data that are presented on social media platforms are not limited to group members there may be a need to alert a user of potential cyber-related vulnerabilities before joining a group.

The techniques described herein provide the ability to calculate and associate cyber-crime vulnerability risk levels with a social group. In addition, the techniques provide a further step of notifying the user at the time of joining the group about the measured risk level prior to the user joining the group.

Turning now to an overview of the aspects of the invention, one or more embodiments of the invention address the above-described shortcomings of the prior art by providing a computer-implemented method, systems, computer program product for generating notifications of a vulnerability risk level when joining a social media group in accordance with one or more embodiments.

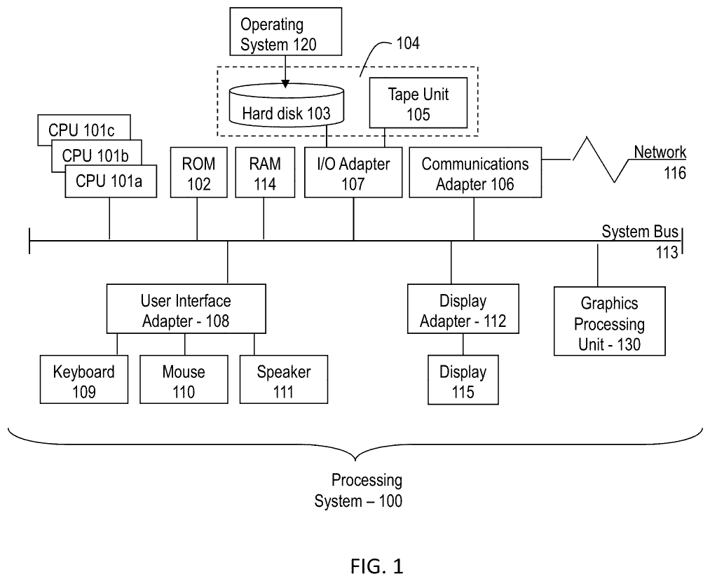

Turning now to a more detailed description of aspects of the present invention, FIG. 1 depicts an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

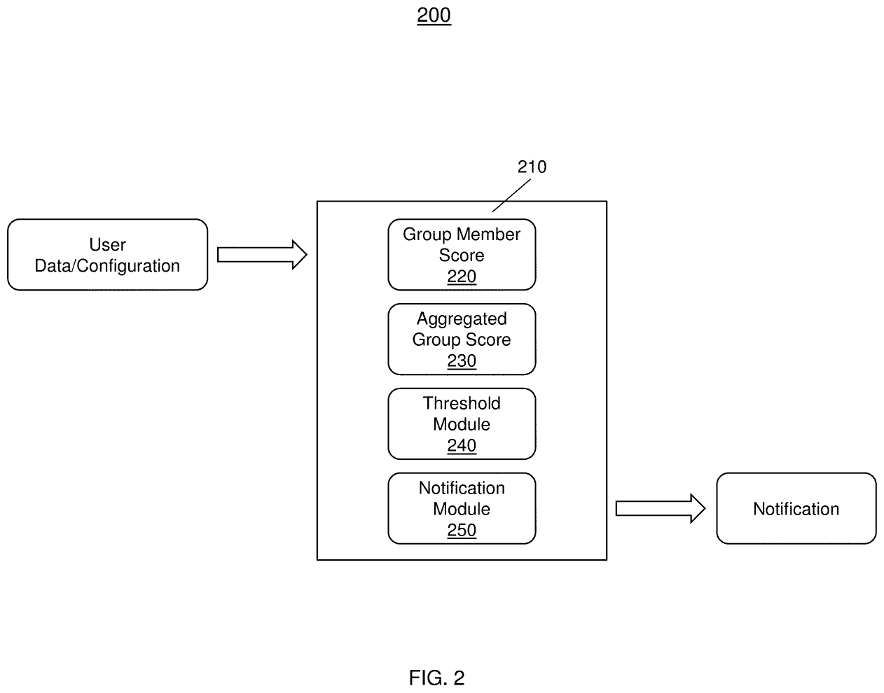

Referring now to FIG. 2, a system 200 for generating notifications of a vulnerability risk level when a user joins a social media group in accordance with one or more embodiments is shown. The system 200 can include one or more components, processors, etc. provided in FIG. 1 and it should be understood that other configurations and architectures can be included.

The system 200 includes an analysis module 210 for analyzing the vulnerability risk level of the members of a social media group. The analysis module 210 receives a plurality of member vulnerability scores, aggregated group scores, and group thresholds, and determines a vulnerability risk level by comparing the aggregated group score and the group threshold as described in detail below. It should be understood that the analysis module 210 can be implemented in hardware and/or software or a combination thereof. The system 200 also includes a member score module 220. The member score module 220 is configured to generate a member score for each member of a particular group by comparing the group member data and configuration information with settings and a configuration that have been determined to minimize the risk to the group. The member score module 220 receives the member data and configuration information from the social network data stores or application program interfaces (APIs). The member data and configuration information includes sensitive data exposure information such as personal information that has been provided in the group and private/public profile settings; authentication data such as the strength of user passwords; security misconfiguration such as unnecessary or out-of-date programs, default program configurations that have not been updated, etc. For example, public/private profile settings control the level of access to the users' information. The more information that is available to non-members or the public, the more vulnerable the users' information is to hackers. In addition, the type of information that is made available to the public such as personal email addresses information, phone numbers, location information, etc. Also, weak authentication data can make the user information more vulnerable to the hackers. Stronger passwords can include, for example, 8 or more characters, upper and lower case requirements, multiple classes of characters (numbers, letters, symbols, etc.), no repeating numbers, no real words, no birthday or identification numbers can be used, etc. These requirements can be used to determine the vulnerability of the group. The security misconfigurations can expose the social network group to hackers in the event out-of-date applications/updates are installed on the user devices, the user may not have installed the security updates with the application exposing the group members to hackers. In addition, the installation of other applications can also make the group members vulnerable to hackers. It should be understood that other factors can be analyzed and used in the system.

The member score can be calculated from the user data and configuration data mentioned above. In one or more embodiments of the invention, each of the member's data and configuration data are analyzed and a score is determined based on meeting the requirements. If the requirement is met, the score is not incremented. If the requirement is not met, the score is incremented. The member score can be on a scale of 1-5, 1-10, 1-100, or any other scale. A member score for a user can be incremented by a value if they have not met the requirements of the group settings and/or configurations. For example, a member score for a user having a public profile can increase the member's score by a value of 1. If a user is exposing personal information such as email addresses, phone numbers, home addresses, etc. to the social media group, the member's score can be incremented for each exposed piece of information. The each piece of personal information can be weighted the same or can be weighted differently. For example, the personal information that is deemed sensitive can be incremented by a value of 2 (higher weight) while other less sensitive information is incremented by a value of 1 (lower weight). The weights can be set by a group administrator or other user. Also, the member's score can be incremented if the passwords are not meeting the requirements of a strong password as defined by the social media group. In addition, the member's score can be incremented based on the number of out-of-date and unnecessary applications/updates. In one or more embodiments of the invention, a password requirement can be weighted higher than a user publishing their email address because the password requirement presents a larger threat to the group.

The final score is added together for all of the members and is provided to the aggregated group score module 230. It should be understood that other factors can be included to determine the member score. For example, another factor can include a group membership requirement that requires an invite from an existing member in order for the user to join the group can be considered as a requirement set by a moderator of the group. Also, restrictions on the type of information that can be published within the group can be considered when determining the member score.

The system 200 includes an aggregated group score module 230. The aggregated group score module 230 receives the individual member scores from the group member score module 220 and adds the scores together to determine a total (aggregate) score for the group.

The aggregated group score module 230 provides the total score to the threshold module 240. The threshold module 240 is configured to generate a group threshold which is a quantitative measure of the minimum level of factors to keep the group safe from a cybercrime. In other embodiments of the invention, a default group threshold and/or a configurable group threshold can be used. For example, using the factors provided above, a user profile configuration such as private/public setting can be required. Also, a minimum password requirement may be required such as having 8 characters. The group may also require the latest version or updates related to the applications be up-to-date. In one or more embodiments of the invention, the minimum level of factors can be determined based on the feedback information indicating a number of hacked users, compromised accounts, or other threats. If the number of incidents increase, the requirements for one or more of the factors can be increased to reduce the chances of the cybercrime.

Based on the current setting for the group, the current group threshold, and the number of successful hacks at the current group threshold, an updated group threshold can be determined. In a non-limiting example, if 5 members, given a particular set of parameters, of a total of 100 members have been hacked then a current group threshold can be determined. The 5% hack rate may be acceptable for a family type group but unacceptable for a public group since the members of a public group may not know one another beyond the group.

If the group threshold is unacceptable which has a 5% hack rate, the set of parameters including the various user data and configuration data requirements, can be modified to achieve the acceptable level for the hack rate. For example, increased password requirements and increased limitations on information the users are allowed to post in the group can reduce the chances of vulnerabilities. Next, the group threshold can be increased and the number of future hacks can be tracked to determine if further parameter modifications and/or group threshold modifications are necessary based on the feedback based.

A vulnerability risk level can be provided based on the difference between the aggregated group score and the group threshold. The vulnerability risk level can indicate a high, medium, or low vulnerability risk level based on the difference between the aggregated group score and the group threshold. The large differences in the aggregated group score and the threshold can indicate a high vulnerability risk level. Smaller difference between the aggregated group score and the group threshold can indicate a low vulnerability risk score. For example, a difference of 20 or more can indicate a high level, a difference of 10-20 can indicate a medium level, and a difference of less than 10 can indicate a low level of risk.

In one or more embodiments of the invention, the group threshold can be updated based on a configurable interval or when a certain number of new users have joined the social media group. The group threshold can by adding a multiple for each additional number of users or a number of members for the group. For example, an average of the member scores can be multiplied by the number of members to determine a group threshold (e.g., average member score (7) multiplied by the number of members (100) is equal to a group threshold of 700).

In another embodiment of the invention, if a configuration of one or more members has changed that is outside of the guidelines for the social media group placing the other members at risk, a notification can be provided to one or more users. In a non-limiting example, if a user updates their password which fails to meet the minimum requirements of the social media group the aggregated group score will be increased. Subsequently, the aggregated group score is compared to the group threshold and the vulnerability risk level will be determined by taking the difference between the aggregated group score and the group threshold. In another non-limiting example, if the user fails to update the latest version of the social media application the aggregated group score is will be updated and compared to the group threshold.

In one or more embodiments of the invention, the type of groups can be identified by the description of the group provided in the group profile or group webpage. In a non-limiting example, group types can include work groups, family groups, interest groups, etc. In another embodiment, the type of group can be determined by the messages that have been exchanged and/or posted in the group. For example, the posts that have been published in the group repeated references a particular company, restaurant, or sport, etc. the type of group may be determined. As previously mentioned, the type of group can indicate the level of the group threshold that may be required. For example, a family type group may allow for a lower group threshold because of the familiarity among the members, while a sports interest group may require a higher threshold because the members may be unknown to one another prior to joining the group.

The notification module 250 transmits a notification to a user, using one or more communication interfaces, prior to joining a social group. In one or more embodiments of the invention, the system 200 may receive a join request from a user wishing to join a particular group and responsive to the request, the system 200 can transmit the notification to the user before the user joins. In one or more embodiments of the invention, the notification is transmitted to the user based on the aggregated group score exceeding the group threshold. The notification can include information indicating the vulnerability risk level, the vulnerability score, factors contributing to the score, etc.

In one or more embodiments of the invention, a notification can be provided to one or more users that are contributing to the high score and the notification can indicate the user configuration or settings that need to be updated. For example, the individual group member scores can be averaged where the group member scores above the average score are considered high scores. Those group members can receive the notification where the notification also indicates the cause of the high score such as exposed personal data, weak passwords, out-of-date applications, etc.

In one or more embodiments of the invention, a notification can be transmitted to the existing members of the social media group to indicate a current vulnerability risk level for the group. After the existing members receive the notification, the group members can decide whether to withdraw from the group or maintain their membership given the updated vulnerability risk level.

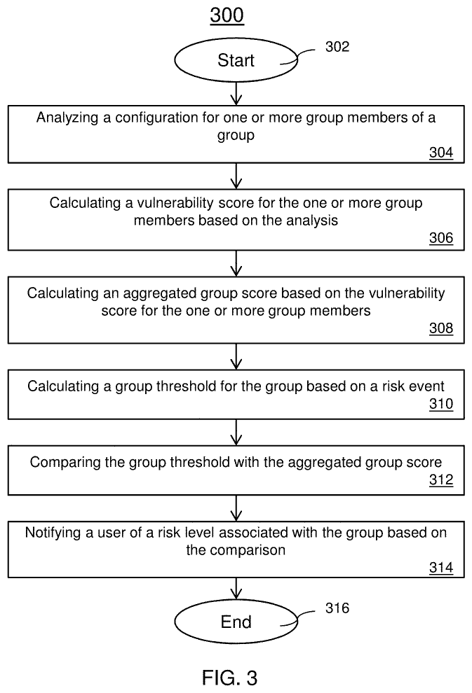

Now referring to FIG. 3, a flowchart of a method 300 for generating notifications of vulnerability risk level when joining a social group in accordance with one or more embodiments is shown. According to an embodiment, the method 300 described in FIG. 3 is utilized to generate notifications of a vulnerability risk level of a user when joining a social network group. The method 300 begins at block 302 and proceeds to block 304 which provides for analyzing user data and configuration data for one or more group members of a group. In one or more embodiments of the invention, the user data and configuration data include the analyzing for each group member exposed information in the social media group, authentication information, security misconfigurations, etc. The user data and configuration data can be obtained from an application program interface, data store, etc.

At block 306, the method 300 provides for calculating a member vulnerability score for the one or more members based on the analysis. The calculation of the vulnerability score is based on comparing the member data and configuration data to a selected configuration and incrementing a score based on failing to meet the requirements of the selected configuration. Block 308 provides for calculating an aggregated group score based on the vulnerability score for the one or more group members. Block 310 provides for calculating a group threshold for the group based on a risk event. The group threshold can indicate a baseline and can indicate the minimal cyber-crime vulnerability countermeasures. In one or more embodiments of the invention, the group threshold can be based on the type of group. For example, a family group may have a higher threshold level because the members have a pre-determined level of trust amongst one another. In a different example, the family group may have a lower threshold level because the members may share more personal information. Similarly, public groups may have different thresholds than private groups.

Block 312 provides for comparing the group threshold and the aggregated group score. The comparison can be used to determine whether to provide a notification to the user. In addition, the comparison can be used to indicate a severity of the vulnerability of the social media group. Block 314 provides for notifying a user of a vulnerability risk level of the group based on the comparison. The notification can include the risk level, the factors contributing to the risk, etc. The method 300 ends at block 316. In one or more embodiments of the invention, the method 300 can be repeated based on a configurable interval, based on a number of new users joining the social group, updates to the user data and configuration data of the group members, etc.

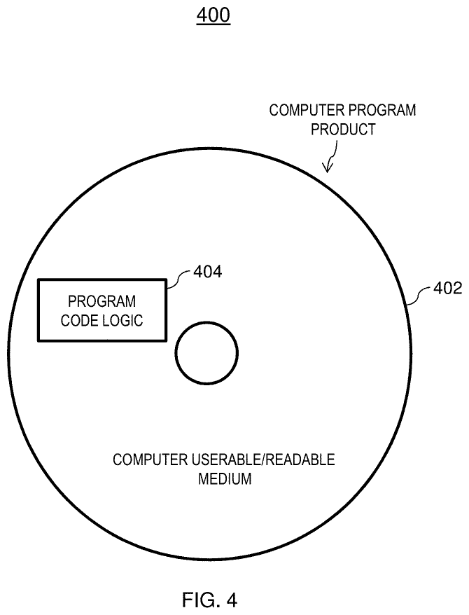

Referring now to FIG. 4, a computer program product 400 in accordance with an embodiment that includes a computer readable storage medium 402 and program instructions 404 is generally shown.

The techniques described herein provide a method that warns a user in real-time, of the vulnerability to cyber-crime of a social group when a user decides to join a social media group by generating a vulnerability score for the social media group. Because the users are provided with varying levels of risk vulnerability information, the users can make decisions as to whether the risks associated with joining the group are reasonable.

The techniques described herein provide for alerting a user of the vulnerability risk levels associated with joining a social media group of interest prior to obtaining membership. The techniques described herein can reduce the exposure of sensitive data, improve authentication requirements, and reduce the sharing of compromised links that can compromise the user data or spread malware/viruses. The techniques include restoring the reputation of a social media group and/or social media platform.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for generating notifications of a vulnerability risk level when joining a social media group, the computer-implemented method comprising:
analyzing user and configuration data for one or more group members of a group;
calculating a vulnerability score for the one or more group members based on the analysis;
calculating an aggregated group score based on the vulnerability score for the one or more group members;
calculating a group threshold for the group based on a risk event;
comparing the group threshold and the aggregated group score; and
notifying a user of a vulnerability risk level of the group based on the comparison.

2. The computer-implemented method of claim 1, wherein the user data and configuration data for the one or more group members comprises at least one of personal data, authentication data, or security misconfiguration data.

3. The computer-implemented method of claim 2, wherein the security misconfiguration data comprises at least one of out-of-date programs or unnecessary programs.

4. The computer-implemented method of claim 2, wherein the authentication data comprises at least one of exposed passwords or a password strength.

5. The computer-implemented method of claim 1, wherein notifying the user is performed before the user joins the group.

6. The computer-implemented method of claim 1, wherein the notification indicates the vulnerability score and the user data and configuration data contributing to the vulnerability score.

7. The computer-implemented method of claim 1, wherein the vulnerability risk level is based on a difference between the aggregated group score and the group threshold.

8. The computer-implemented method of claim 1, wherein the group threshold is based at least in part on a group type.

9. A system for generating notifications of a vulnerability risk level when joining a social media group, the system comprising:
a storage medium, the storage medium being coupled to a processor;
the processor configured to:
analyze user data and configuration data for one or more group members of a group;
calculate a vulnerability score for the one or more group members based on the analysis;
calculate an aggregated group score based on the vulnerability score for the one or more group members;
calculate a group threshold for the group based on a risk event;
compare the group threshold and the aggregated group score; and
notify a user of a vulnerability risk level of the group based on the comparison.

10. The system of claim 9, wherein the user data and configuration data for the one or more group members comprises at least one of personal data, authentication data, or security misconfiguration data.

11. The system of claim 10, wherein security misconfiguration data comprises at least one of out-of-date programs or unnecessary programs, and wherein the authentication data comprises at least one of exposed passwords or password strength.

12. The system of claim 9, wherein notifying the user is performed before the user joins the group.

13. The system of claim 9, wherein the notification indicates the vulnerability score and the user data and configuration data contributing to the vulnerability score.

14. The system of claim 9, wherein the vulnerability risk level is based on a difference between the aggregated group score and the group threshold.

15. A computer program product for generating notifications of a vulnerability risk level when joining a social media group, the computer program product comprising:
a computer readable storage medium having stored thereon program instructions executable by a processor, wherein the program instructions cause the processor to:
analyze user data and configuration data for one or more group members of a group;
calculate a vulnerability score for the one or more group members based on the analysis;
calculate an aggregated group score based on the vulnerability score for the one or more group members;
calculate a group threshold for the group based on a risk event;
compare the group threshold and the aggregated group score; and
notify a user of a vulnerability risk level of the group based on the comparison.

16. The computer program product of claim 15, wherein the user and configuration data for the one or more group members comprises at least one of personal data, authentication data, or security misconfiguration data.

17. The computer program product of claim 16, wherein security misconfiguration data comprises at least one of out-of-date programs or unnecessary programs, and wherein the authentication data comprises at least one of exposed passwords or password strength.

18. The computer program product of claim 15, wherein notifying the user is performed before the user joins the group.

19. The computer program product of claim 15, wherein the notification indicates the vulnerability score and the user data and configuration data contributing to the vulnerability score.

20. The computer program product of claim 15, wherein the vulnerability risk level is based on a difference between the aggregated group score and the group threshold.
